(19) United States
(12) Patent Application Publication
(10) Pub. No.: US 2026/0298283 A1
(43) Pub. Date: Oct. 1, 2026

(54) MOTOR-VEHICLE LOCK

(71) Applicant: Kiekert Aktiengesellschaft, Heiligenhaus (DE)

(72) Inventors: Octavian Cimpean, Rochester Hills, MI (US); Jeff Duncan, Howell, MI (US)

(73) Assignee: Kiekert Aktiengesellschaft, Heiligenhaus (DE)

(21) Appl. No.: 19/092,018

(22) Filed: Mar. 27, 2025

(51) Int. Cl. E05B 79/20

(52) U.S. Cl. CPC F16C 1/14; E05B 79/20; F16C 1/16

(57) ABSTRACT

A Bowden cable end piece of a Bowden cable is connected to an actuating means in a motor vehicle, in particular an inside door handle and/or an outside door handle and/or a motor-vehicle lock, having a positive-locking receptacle in the actuating means into which the Bowden cable end piece is capable of being inserted and a guide groove in the actuating means through which a Bowden cable core is capable of being guided, wherein the Bowden cable end piece is capable of being held in a separate plastics material component in the receptacle.

The invention relates to a connection of a Bowden cable end piece of a Bowden cable to an actuating means in a motor vehicle, in particular to an inside door handle and/or a motor-vehicle lock, comprising a positive-locking receptacle in the actuating means into which the Bowden cable end piece is capable of being inserted and a guide groove in the actuating means through which a Bowden cable core is capable of being guided.

Bowden cables are often used for force transmission in today's motor vehicles, which cables can transmit an external force flexibly over a distance and introduce it into a functional unit in a targeted manner. For example, Bowden cables are used where a force is to be transmitted to a motor-vehicle lock by means of, for example, an inside door handle and/or an outside door handle, so that a mechanical unlocking of the motor-vehicle lock is made possible. The motor-vehicle lock acts as the functional unit here.

In addition to the door handle, it is however also conceivable and known from the prior art to use the Bowden cable between an externally arranged closing device and a motor-vehicle lock. The force generated in the closing device can then be transmitted to the motor-vehicle lock by means of the Bowden cable. Here it is conceivable, for example, that the closing device automatically transfers a locking mechanism in the lock from a pre-ratchet position to a main ratchet position. The use of a Bowden cable in conjunction with a motor-vehicle lock can therefore be carried out in many different ways, wherein the areas of application of the Bowden cable can be adapted to the requirements in the motor vehicle and offers various connection options.

The Bowden cable itself consists of a Bowden cable core, which consists of a wire rope, wherein the wire rope has an installation means at its end which can also be referred to as a Bowden cable end piece. The Bowden cable core is guided in a Bowden cable sheath, which acts as a guide element for the Bowden cable core and offers the advantage that a transmission of force can be flexibly redirected. The Bowden cable can therefore also be used where a direct connection of the functional unit to the motor-vehicle lock is not possible. The Bowden cable sheath is preferably made of plastics material and can have a metal insert as a permanently stable contact surface for the Bowden cable core. Fastening means are preferably provided at the ends of the Bowden cable sheath, which make it possible to insert the free ends of the Bowden cable sheath into the functional unit and/or the motor-vehicle lock and to install the Bowden cable. In order to ensure that the Bowden cable is installed correctly and without play, it is possible to adjust the Bowden cable in relation to the motor-vehicle lock in the region of the Bowden cable end piece in order to avoid unwanted noise. For this purpose, solutions are known from the prior art.

From DE 10 2021 100 390, a motor-vehicle lock is known comprising a locking mechanism with a catch and at least one pawl, a plastics material housing, a Bowden cable, wherein a free end of the Bowden cable, in particular a Bowden cable sheath, can be inserted into the plastics material housing and installed in the motor-vehicle lock, and an adjustable fastening means for the free end of the Bowden cable sheath is provided in the plastics material housing, wherein at least part of an installation region of the free end can be closed by means of a cover movably attached to the housing and wherein the Bowden cable can be fixed in an adjusted installation position by means of the cover. If the Bowden cable is installed on the motor-vehicle lock housing, wherein the free end or the connecting piece is for example inserted into the housing and the Bowden cable core is inserted into, for example, an external operating lever with, for example, a nipple installed on the end of the Bowden cable core, it may happen that play in the lever mechanism has to be compensated for. In this case, the nipple would fit into the external operating lever with play, which could lead to unwanted noise. This play can be compensated for by adjusting the free end of the Bowden cable sheath in relation to the motor-vehicle lock housing.

In order to connect the Bowden cable to, for example, an inside door handle or a motor-vehicle lock, it is known from DE 10 2018 120 798 A1 to insert the Bowden cable into a coupling element of a clutch lever. For this purpose, the clutch lever has a positive-locking receptacle into which a nipple of a Bowden cable core can be inserted with a positive fit. In addition, the clutch lever has a guide groove into which the Bowden cable core can be inserted in a positive-fitting and secure manner. Another nipple is located at one end of the Bowden cable core. The nipples are preferably non-detachably connected to the Bowden cable core.

A Bowden cable connection of this kind is also known for example from DE 10 2022 130 548A1. The publication discloses a coupling element in the form of a traction cable, which in conjunction with the here tube-or sleeve-shaped fastening portion forms a Bowden cable having a nipple at one end. This nipple is hooked into a corresponding coupling interface on the door handle, just like the purely mechanical door locking device of the Bowden cable provided there.

The solutions known from the prior art for installing a Bowden cable on a motor-vehicle lock have proven themselves in principle. Problems arise when unwanted noises are produced that can impair the operator's comfort and perception of quality. This is where the invention starts.

The object of the invention is to provide an improved motor vehicle lock. In particular, an object of the invention is to facilitate installation of the Bowden cable and at the same time to avoid or reduce to a minimum the possibility of noise occurring in the interaction between the Bowden cable end piece and the fastening means. Furthermore, it is an object of the invention to provide a cost-effective and structurally simple possibility of installing a Bowden cable.

The object is achieved by the features of independent claim 1. Advantageous embodiments of the invention are specified in the dependent claims. It should be noted that the exemplary embodiments described below are not restrictive; rather, any options for variation of the features described in the description and the dependent claims and the drawings are possible.

The object of the invention is achieved in that a connection of a Bowden cable end piece of a Bowden cable to an actuating means in a motor vehicle, in particular to an inside door handle and/or a motor-vehicle lock, is provided, comprising a positive-locking receptacle in the actuating means into which the Bowden cable end piece is capable of being inserted and a guide groove in the actuating means through which a Bowden cable core is capable of being guided, wherein the Bowden cable end piece is capable of being held in a separate plastics material component in the receptacle. The structure according to the invention makes it possible to mount the Bowden cable end piece in the receptacle in such a way that noises between the Bowden cable end piece and the receptacle element or coupling element can be prevented. The plastics material component is designed to be positioned between the Bowden cable end piece and the receptacle and thus serves as a sliding partner between the Bowden cable end piece and the receptacle. In particular, when the Bowden cable end piece and the receptacle are made of a metal material, the plastics material component forms a friction partner between the Bowden cable end piece and the receptacle or the coupling element.

The Bowden cable is used to transmit tensile forces that are driven manually or electromechanically. This can lead to movements in the Bowden cable itself, which must be carried out to move, for example, an inside door handle. In particular, a pivoting movement of an inside door handle requires that the inside door handle and thus the receptacle for the Bowden cable end piece move relative to each other. During this sliding movement, noise emissions can occur due to the material pairing and the force present in the Bowden cable. By using the plastics material component between the Bowden cable end piece and the receptacle, noise can be effectively eliminated.

The connection according to the invention is used where a force is transmitted in the motor vehicle by means of a Bowden cable. For this purpose, an end piece is formed on the Bowden cable core, which preferably has a cylindrical shape. This Bowden cable end piece is also referred to as a Bowden cable nipple. For example, the Bowden cable end piece can be hooked into an inside door handle and its second end can be connected to an inside operating lever in the motor-vehicle lock. However, it is also conceivable that the Bowden cable is used, for example, on an outside door handle, wherein the Bowden cable is then arranged between the outside door handle and an external operating lever in the motor-vehicle lock. Other areas of application, listed non-exhaustively, may include a closing aid, a hood latch, a tailgate lock, a seat lock, etc. In each case, the Bowden cable end piece is inserted into a receptacle of an operating lever so that a force can be introduced or transmitted into the Bowden cable by means of the Bowden cable when the actuating means is actuated.

It has proven to be advantageous if the plastics material component accommodates the Bowden cable end piece in a positive-fitting manner, at least in some regions. According to the invention, the plastics material component can be adapted to the shape of the Bowden cable end piece, so that at the same time an assembly lock for the Bowden cable can be provided. The positive engagement of the Bowden cable end piece in the plastics material component allows the plastics material component to be designed so that it can be adapted to the receptacle. The Bowden cable end pieces are manufactured in large series and equipped with correspondingly standardized end pieces. In order to be able to make a corresponding adjustment to the shape of the receptacle, the plastics material component can on the one hand be attached to the Bowden cable end piece in a positively fitted manner and on the other hand be designed in such a way that a secure position of the plastics material component in the receptacle of the actuating means is provided. The plastics material component thus acts as an adapter between the Bowden cable end piece and the receptacle. This makes it possible to provide favorable engagement conditions between the plastics material component and the receptacle.

It is further advantageous and a variant embodiment of the invention if the Bowden cable end piece has a cylindrical shape and the cylindrical shape is attached to the Bowden cable core transversely to a longitudinal extension of the Bowden cable core. A cylindrical shape on the Bowden cable end piece and a correspondingly adapted shape on the plastics material component allow favorable engagement conditions between the Bowden cable and the actuating means. A correspondingly adapted radius allows favorable sliding properties, so that sliding with low frictional resistance on the plastics material component can be achieved during a pivoting movement of the actuating means. The cylindrical shape also offers a high degree of security when hooking the Bowden cable end piece into the receptacle, in particular when a Bowden cable core is arranged centrally on the Bowden cable end piece. In this case, two engagement regions can be realized between the receptacle and the Bowden cable end piece. A support on both sides of the cylindrical Bowden cable end piece reduces the surface pressure in the receptacle and at the same time offers secure installation and a high degree of operational reliability.

Furthermore, it has proven to be advantageous if the plastics material element can be fixed by means of the Bowden cable end piece. Fastening or standardization of the plastics material element by means of the Bowden cable end piece makes it possible to hold the plastics material element securely in a defined position in relation to the receptacle. In other words, the Bowden cable end piece holds the plastics material element in an aligned position so that a secure and aligned fit of the plastics material element in relation to the Bowden cable end piece and accordingly in relation to the receptacle can be realized.

In a preferred embodiment, the plastics material element can be inserted into the Bowden cable end piece. The Bowden cable end piece therefore has a dual function. On the one hand, the Bowden cable end piece serves to transmit force from the Bowden cable to the actuating device, and on the other hand the Bowden cable end piece can serve to accommodate the plastics material element. The advantage of inserting it is that it allows for secure installation. If, for example, the plastics material element is inserted into a groove in the Bowden cable end piece, then the position of the plastics material element can be secured during installation.

It has turned out here that it can be particularly advantageous if the Bowden cable end piece engages over the plastics material element at the edge, at least in certain regions. A further fixing or positional securing of the plastics material element relative to the Bowden cable end piece can be achieved by the Bowden cable end piece engaging over the plastics material element at the edge. In other words, the plastics material element can be positioned or accommodated on the Bowden cable end piece in such a way that the plastics material element is given a lateral fixing in a sliding on the Bowden cable end piece. For example, if the Bowden cable end piece is cylindrical and the plastics material element engages over the Bowden cable end piece in the longitudinal direction of the cylinder, protruding edges on the Bowden cable end piece can secure the plastics material element in the longitudinal direction of the cylinder. The plastics material element preferably projects beyond the edge of the Bowden cable end piece so that a plastics material bearing of the Bowden cable end piece can be guaranteed in any case relative to the receptacle.

In a further design variant, an advantage arises if the plastics material component can be connected to the Bowden cable end piece with a positive fit. A positive fit can provide additional positional securing of the plastics material component. In particular, the positive engagement can provide a secure position, but also secure positioning. In addition, installation protection can be provided by a predetermined positive fit. If, for example, guide grooves are provided in the plastics material component and/or Bowden cable end piece, and, in addition, merely as an example there is an asymmetrical structure in the interaction between the plastics material component and the Bowden cable end piece, a clear positioning between the Bowden cable end piece and the plastics material component can be specified. It can also be advantageous if the plastics material component is designed to be elastically expandable. In addition to the property of good sliding and noise minimization, plastics materials have the advantage that they can be elastically deformed, at least in some regions. If the plastics material component is designed in such a way that the plastics material component engages over the Bowden cable end piece at least in some regions and is constructed for example in a C-shape, the plastics material component can be pushed or installed over a thickened portion of the Bowden cable end piece by expanding the plastics material component, wherein elastic deformation and latching on the Bowden cable end piece makes elastic installation possible. A spring-loaded expansion of the plastics material component, together with a positive-fitting design, then allows the plastics material component to be clipped onto the Bowden cable end piece.

If the Bowden cable end piece has at least one groove, wherein the plastics material component has at least one rib that can be inserted into the groove, this results in a further design variant of the invention. A so-called tongue and groove connection between the Bowden cable end piece and the plastics material element can support a latching and/or positive connection. In particular, if the Bowden cable end piece is designed cylindrical and transverse to a connection to the Bowden cable, a corresponding design of the plastics material component can allow the plastics material element to be easily clipped and latched onto the Bowden cable end piece. Advantageously, the grooves can extend in a longitudinal direction, i.e. along an extension of the cylindrical structure of the Bowden cable end piece, and/or, as already stated above, can extend in the transverse direction to the cylindrical structure of the Bowden cable end piece in the Bowden cable end piece. This means that on the one hand installation protection and/or installation assistance can be provided and at the same time a fixing of the plastics material element to the Bowden cable end piece that is correct in terms of shape and position can be provided.

The invention is explained in more detail below with reference to the attached drawings on the basis of a preferred exemplary embodiment. However, the principle applies that the exemplary embodiment does not limit the invention, but is merely an advantageous embodiment. The features shown can be implemented individually or in combination with further features of the description as well as the claims.

### IN THE FIGURES

FIG. 1 schematically shows the principle of the connection of a Bowden cable end piece of a Bowden cable to an actuating means in a motor vehicle, here using the example of an inside door handle,

FIG. 2 is a three-dimensional view of a Bowden cable end piece fitted with a plastics material component on a Bowden cable core, and

FIG. 3 is a three-dimensional representation of a separate Bowden cable end piece and a plastics material component before installation.

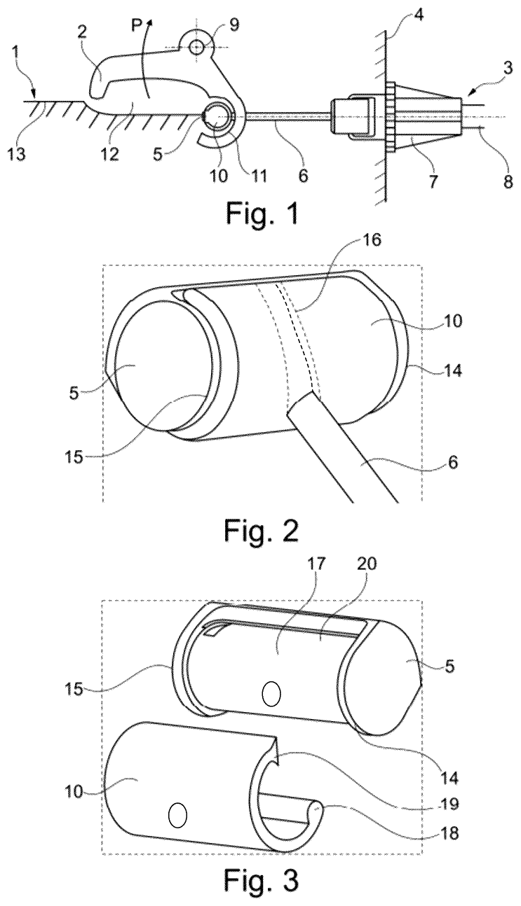

FIG. 1 shows the design of a part of a motor vehicle 1 and in particular an actuating means 2 in principle. The actuating means 2 is shown here in principle as an inside door handle 2. A Bowden cable 3 is connected to the actuating means 2, wherein the Bowden cable 3 is shown installed on a door module support 4. The Bowden cable 3 has a Bowden cable end piece 5, a Bowden cable core 6, an installation element 7, and a Bowden cable sheath 8.

The inside door handle 2 is accommodated in the motor vehicle so as to be pivotable about a position 9, wherein a plastics material component 10 is arranged in a receptacle 11 of the inside door handle 2. The operator is able to reach into a recess 12 in a door panel 13 and move the inside door handle 2 about the axis 9 in the direction of the arrow P. Moving the inside door handle 2 can generate a tensile force F in the Bowden cable 3 and, for example, unlock and/or lock a motor-vehicle lock (not shown but connected to the Bowden cable 3).

FIG. 2 is a three-dimensional view of the Bowden cable end piece 5 with a plastics material component 10 installed thereon at a connection to a Bowden cable core 6. It can be clearly seen that the plastics material component 10 is held between two stops 14, 15 on the edge of the Bowden cable end piece 5. At the same time, the plastics material component 10 is substantially C-shaped and designed to engage over the Bowden cable end piece. To install the plastics material component 10, the plastics material component can be installed over the Bowden cable core 6 before installing or fastening the Bowden cable end piece 5 to the Bowden cable core or, shown merely as an example, the plastics material component 10 can have a recess 16 by means of which the plastics material component 10 can be subsequently connected to the Bowden cable end piece 5. Overall, the Bowden cable end piece 5 in combination with the plastics material component 10 has a cylindrical extension which is formed at right angles to the Bowden cable core.

In FIG. 3, the Bowden cable end piece 5 and plastics material component 10 are shown as separate components. The cylindrical extension 17 of the Bowden cable end piece 5 is clearly visible. In addition, ribs 18, 19 are arranged on the plastics material component 10, which can be clipped or snapped into grooves 20 arranged on both sides of the Bowden cable end piece 5. By means of the corresponding structure of the Bowden cable end piece 5 and a correspondingly adapted design of the plastics material component 10, a secure connection and holding of the plastics material component 10 on the Bowden cable end piece 5 can be realized. It is conceivable and shown in this exemplary embodiment that differently designed ribs 18, 19 can also engage in differently shaped grooves 20 in the Bowden cable end piece 5. If, for example, as shown in FIG. 3, a pointed rib 19 is hooked into the groove 20, an easy and secure latching of the further rib 18 on the opposite side of the Bowden cable end piece 5 can be realized. The edge stops 14, 15 are here designed such that the plastics material component 10 projects beyond the edge stops 14, 15 in the installed state. This ensures that the plastics material component 10 is positioned in the receptacle 11 of the inside door handle 2 in any installation state.

The plastics material component 10 allows the plastics material component 10 to slide in the receptacle 11 of the door handle 2 during a pivoting movement of the inside door handle 2. In addition to the good sliding properties of the plastics material, the plastics material component 10 can also act as a damping means. If, for example, there is play between the Bowden cable 3 and the inside door handle 2, unpleasant noises can occur, especially if the inside door handle 2 is made at least partly of a metal material. The Bowden cable end piece 5 is also preferably made of a metal material, so that the plastics material component 10 acts as a lubricant and noise-dampening means between the actuating means 2 and the Bowden cable 3. Overall, an advantageous structure for the connection of a Bowden cable end piece 5 of a Bowden cable 3 to an actuating means 2 in a motor vehicle 1 can be provided. The plastics material component 10 minimizes the production of noise when there is play between the Bowden cable 3 and the actuating means 2 and at the same time acts as a sliding partner in the event of sliding or moving engagement between the Bowden cable 3 and the actuating means 2.

### LIST OF REFERENCE SIGNS

1 motor vehicle
2 actuating means, inside door handle
3 Bowden cable
4 door module support
5 Bowden cable end piece
6 Bowden cable core
7 installation element
8 Bowden cable sheath
9 axis
10 plastics material component
11 receptacle
12 recess
13 door panel
14, 15 stop
16 recess
17 cylindrical extension
18, 19 rib
20 groove
P Arrow
F tensile force

1. A connection arrangement for connecting a Bowden cable to an actuator in a motor vehicle, comprising:
a Bowden cable end piece;
a separate plastics material component; and
a positive-locking receptacle in the actuator, wherein the Bowden cable end piece and the separate plastics material components are inserted into the receptacle,
wherein the Bowden cable end piece includes a groove and the plastics material component includes a rib,
wherein the plastics material component is attached to the Bowden cable end piece when the rib is inserted into the groove, and
wherein the Bowden cable end piece is held in the separate plastics material component in the receptacle such the Bowden cable end piece and the plastics material component pivot together in the receptacle of the actuator during actuation of the actuator.

2. The connection arrangement according to claim 1, wherein the plastics material component receives the Bowden cable end piece in a positively fitting manner at least in regions.

3. The connection arrangement according to claim 1, wherein the Bowden cable end piece has a cylindrical extension, and the cylindrical extension is fastened to a Bowden cable core of the Bowden cable transversely to a longitudinal extension of the Bowden cable core.

4. The connection arrangement according to claim 3, wherein the Bowden cable core is arranged centrally on the Bowden cable end piece.

5. (canceled)

6. The connection arrangement according to claim 1, wherein the plastics material component is inserted into the Bowden cable end piece.

7. The connection arrangement according to claim 1, wherein the Bowden cable end piece engages over the plastics material component at an edge of the plastics material component.

8. The connection arrangement according to claim 1, wherein the plastics material component is connected with a positive fit to the Bowden cable end piece.

9. (canceled)

10. The connection arrangement according to claim 1, wherein the plastics material component is elastically expandable.

11. The connection arrangement according to claim 7, wherein the Bowden cable end piece includes a cylindrical extension and two stops protruding from opposite ends of the cylindrical extension, wherein the plastics material component is positioned between the two stops when the plastics material component is attached to the Bowden cable end piece.

12. The connection arrangement according to claim 1, wherein the Bowden cable end piece further includes a second groove and the plastics material component includes a second rib,
wherein the plastics material component is attached to the Bowden cable end piece when the second rib is inserted into the second groove, and
wherein the rib and the second rib are different.

13. The connection arrangement according to claim 12, wherein the rib is a pointed rib.

14. The connection arrangement according to claim 1, wherein the plastics material component further includes a recess that extends along a portion of the plastics material component, and the Bowden cable is inserted into the recess when attaching the plastics material component to the Bowden cable end piece.

15. (canceled)

16. The connection arrangement according to claim 10, wherein the plastics material component includes an inner contour, and
wherein a cross-section of the Bowden cable end piece is larger than a cross-section of the inner contour such that the plastics material component expands when the plastics material component is attached to the Bowden cable end piece.
